(19) United States
(12) Patent Application Publication
(10) Pub. No.: US 2017/0061434 A1
(43) Pub. Date: Mar. 2, 2017

(54) METHODS AND APPARATUS FOR ANALYZING FINANCIAL TRANSACTION DATA

(71) Applicant: MasterCard International Incorporated, Purchase, NY (US)

(72) Inventors: Rakesh Kumar Tiwari, Delhi (IN); Abhishek Gautam, Delhi (IN); Shashank Kumar Trivedi, New Delhi (IN)

(21) Appl. No.: 15/241,278

(22) Filed: Aug. 19, 2016

(30) Foreign Application Priority Data
Aug. 28, 2015 (SG) 10201506822R

(51) Int. Cl. G06Q 20/40; G06Q 20/10

(52) U.S. Cl. CPC G06Q 20/405; G06Q 20/108

(57) ABSTRACT

In an embodiment a computer implemented method of analyzing financial transaction data, the method comprises, receiving, at a server of a payment network, an indication of a merchant from an issuing bank; determining, using the received indication, a merchant identifier that uniquely identifies the merchant in transaction data stored on a payment network data warehouse; extracting data corresponding to transactions at the merchant from the transaction data using the merchant identifier; analyzing the data corresponding to transactions at the merchant to determine key performance indicators for the merchant.

### CROSS-REFERENCE TO RELATED APPLICATION

This application is a U.S. National Stage filing under 35 U.S.C. §119, based on and claiming benefit of and priority to SG Patent Application No. 10201506822R filed Aug. 28, 2015.

### TECHNICAL FIELD AND BACKGROUND

The present disclosure relates to a method and system for processing financial transaction data. In particular, it provides a method and system for processing a financial transaction data to provide key performance indicators and relative market data using transaction data for a merchant.

Transaction data can provide valuable insights for businesses. A business may use such insights to target promotions or offers to key customer groups. Further such insights may allow businesses to assess the effectiveness of such promotions and offers.

Card issuers often provide card services to both consumer cardholders and commercial cardholders. Merchants such as retailers and other service providers may themselves be commercial cardholders of cards from a card issuer. One challenge that card issuers face how to provide actionable insights to merchants.

### SUMMARY

In general terms, the present disclosure proposes a method and apparatus for processing transaction data. In the proposed method and system, transactions corresponding to a merchant are identified in a payment network data warehouse. The data on these transactions is analyzed to provide key performance indicators for the merchant.

According to a first aspect, there is provided a computer implemented method of analyzing financial transaction data, the method comprising, receiving, at a server of a payment network, an indication of a merchant from an issuing bank; determining, using the received indication, a merchant identifier that uniquely identifies the merchant in transaction data stored on a payment network data warehouse; extracting data corresponding to transactions at the merchant from the transaction data using the merchant identifier; and analyzing the data corresponding to transactions at the merchant to determine key performance indicators for the merchant.

In an embodiment the method further comprises extracting data corresponding groups of merchants from the transaction data; and analyzing the data corresponding to transactions at the merchant using the data corresponding to groups of merchants to provide relative market indicators for the merchant.

In an embodiment, the relative market indicators comprise market share indicators for the merchant.

In an embodiment, the data corresponding to groups of merchants is anonymized data having merchant identifiers removed.

In an embodiment, the received indication comprises merchant location information and merchant identity information.

In an embodiment, determining, using the received indication, a merchant identifier that uniquely identifies the merchant in transaction data stored on a payment network data warehouse comprises using the merchant location information to determine a set of possible merchant identifiers and using the merchant identity information to determine a merchant identifier from the set of possible merchant identifiers.

In an embodiment, the merchant location information to determine a set of possible merchant identifiers comprises performing an inner join using the merchant location information.

According to a second aspect, there is provided an apparatus for analyzing financial transaction data. The apparatus comprises: a computer processor and a data storage device, the data storage device having matching module and a merchant data extraction and analysis module comprising non-transitory instructions operative by the processor to: receive, an indication of a merchant from an issuing bank; determine, using the received indication, a merchant identifier that uniquely identifies the merchant in transaction data stored on a payment network data warehouse; extract data corresponding to transactions at the merchant from the transaction data using the merchant identifier; and analyze the data corresponding to transactions at the merchant to determine key performance indicators for the merchant.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram illustrating entities involved in processing a transaction;

FIG. 2 is a block diagram illustrating a scenario in which a bank stores data for both commercial customers and consumers;

FIG. 3 is a block diagram illustrating a technical architecture of the apparatus according to an embodiment;

FIG. 4 is a flow diagram showing a method of processing transaction data according to an embodiment;

FIG. 5 shows data sets used in a method of processing transaction data according to an embodiment;

FIG. 6 shows a process of matching merchant data in a method of processing transaction data according to an embodiment;

FIG. 7 shows processing of merchant data to determine key performance indicators (KPIs);

FIG. 8 shows processing of merchant data and market data to determine relative market indications; and

FIG. 9 shows data required to uniquely identify a merchant in an embodiment.

### DETAILED DESCRIPTION

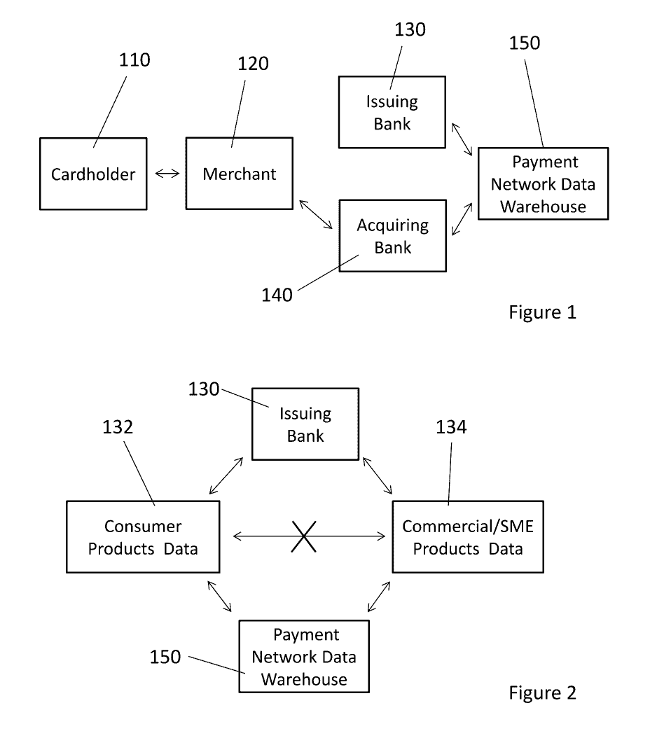

FIG. 1 illustrates the entities involved in processing a typical transaction. As shown in FIG. 1, a cardholder 110 and a merchant 120 initiate a transaction. The transaction may involve the purchase of goods from the merchant 120 by the cardholder 110. In order to process the transaction, information concerning the transaction is transferred to an issuing bank 130 and an acquiring bank 140. The issuing bank 130 holds details of an account in the name of the cardholder 110 and the acquiring bank 140 holds details of an account in the name of the merchant 120. In order to process the transaction, the issuing bank 130 and the acquiring bank 140 exchange information to authorize and execute the transaction. This information exchange takes place through a payment network. Both the issuing bank 130 and the acquiring bank provide information to a payment network data warehouse 150 which stores information on transactions carried out using the payment network.

The payment network data warehouse may be implemented as a server coupled to one or more databases storing data. The server may be configured to handle requests and/or communications from terminals associated with parties involved in a transaction carried out over the payment network. The payment network can be any electronic payment network which connects, directly and/or indirectly payers (consumers and/or their banks or similar financial institutions) with payees (the merchants and/or their banks or similar financial institutions). Non-limiting examples of the payment network are a payment card type of network such as the payment processing network operated by MasterCard, Inc. The various communication may take place via any types of network, for example, virtual private network (VPN), the Internet, a local area and/or wide area network (LAN and/or WAN), and so on.

Many financial institutions have both consumers and commercial customers. This scenario is illustrated in FIG. 2. The consumers may be for example personal card holders who use the cards issued to pay for personal goods and services. The commercial customers may be for example corporate card holders like Small and Mid-Size Merchants (SMEs) who use the cards issued to pay commercial expenses.

FIG. 2 illustrates a scenario in which a bank has both commercial customers and consumers. As shown in FIG. 2, the issuing bank 130 produces consumer products data 132 and Commercial/SME Products data 134. Consumer products data 132 relates to banking cards such as credit cards, debit cards, or pre-paid cards provided to consumers. Commercial/SME Products data 134 relates to banking cards such as credit cards, debit cards, or pre-paid cards provided to commercial customers. The consumer products data 132 comprises information on consumers and the transactions made by those consumers. The Commercial/SME Products data 134 comprises information on commercial customers such as name of the retailer, its locations and information on transactions made by those commercial customers.

As shown in FIG. 2, in many issuing banks, data from a consumer products portfolio, for example the consumer products data 132 is not linked to data from a commercial product portfolio, for example the Commercial/SME Products data 134. Embodiments described herein provide methods and systems to allow provision of actionable insights about shoppers' behavioral patterns to merchants. Information from both the consumer products data 132 and the Commercial/SME Products data 134 is provided to the payment network data warehouse 150.

The data stored in the payment network data warehouse 150 is stored in multiple tables. The two key tables used in embodiments of the present invention are Transaction details and Merchant details. The Transaction details table includes information such as transaction amount, count, product or product group and the merchant table includes information about location of merchants like merchant location, merchant name, address, post code etc. The data in these tables is used to match merchants such as retailers to transactions carried out by customers of those organizations.

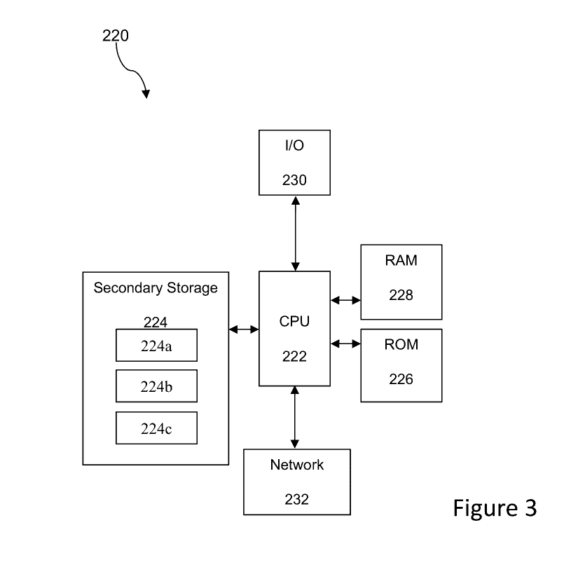

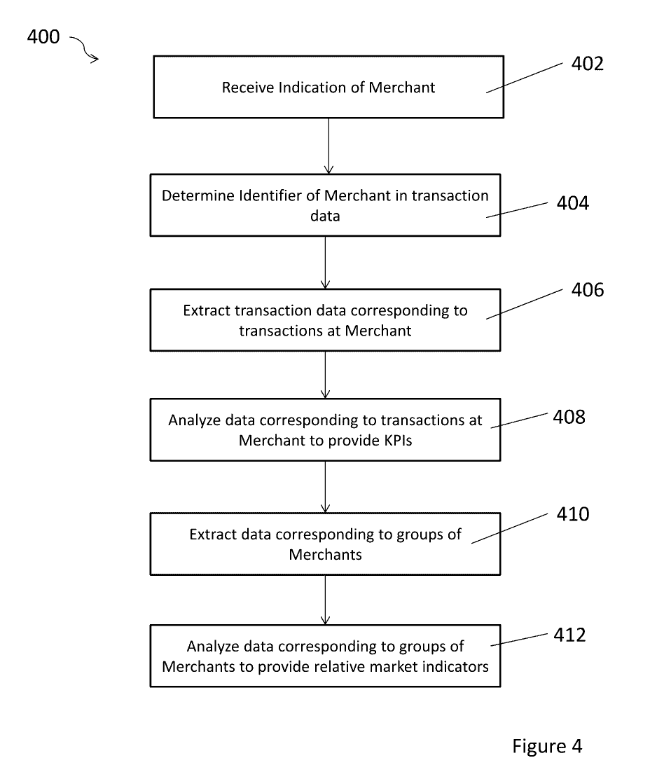

FIG. 3 is a block diagram showing a technical architecture of the server of the payment network data warehouse 150 for performing an exemplary method 400 which is described below with reference to FIG. 4. Typically, the method 400 is implemented by a computer having a data-processing unit. The block diagram as shown FIG. 3 illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a matching component 224a, a merchant data extraction and analysis component 224b and a market data extraction and analysis component 224c comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 400 will now be described with reference to FIG. 4 in respect of analysis of transactions involving a merchant to provide key performance indicator and also an analysis of market data to provide relative market indicators. It should be noted that enumeration of operations is for purposes of clarity and that the operations need not be performed in the order implied by the enumeration.

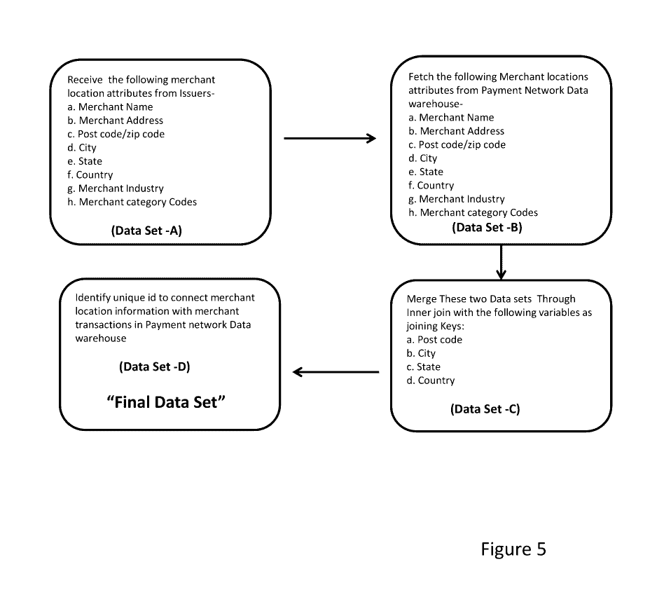

In step 402, an indication of a merchant is received by the payment network data warehouse 150 from the issuing bank 130. The indication of the merchant specifies a merchant on which to carry out analysis of transactions. The indication of the merchant may include merchant location attributes. Examples of possible merchant locations attributes are described below with reference to FIG. 5 in which Data Set A shows a set of possible merchant location attributes.

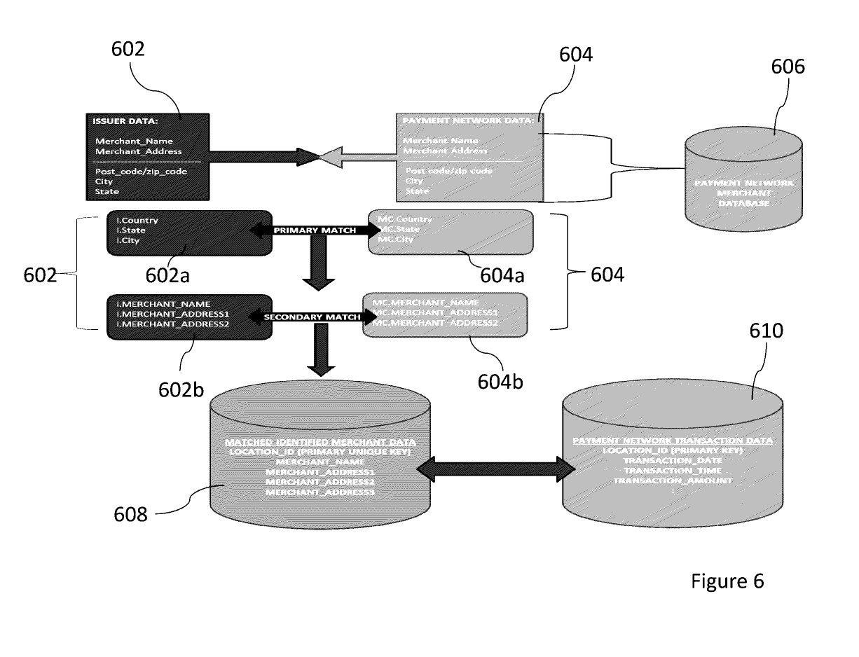

In step 404, the matching component 224a of the server determines an identifier of the merchant which can be used to extract transaction data relating to the merchant from the payment network data warehouse 150. The process carried out by the matching component 224a is described in more detail below with reference to FIGS. 5 and 6.

FIG. 5 illustrates the process of identifying a unique merchant identifier to connect merchant location attributes for a merchant received from the issuing bank with merchant transactions stored in the payment network data warehouse.

Data Set A shown in FIG. 5 comprises the merchant location attributes received from the issuing bank. As shown in FIG. 5, Data Set A comprises: a) Merchant Name; b) Merchant Address; c) Post code or zip code; (d) City; (e) State; (f) Country; (g) Merchant Industry; and (h) Merchant Category Codes.

In order to match the merchant indicated by the indication received from the issuing bank with a merchant identifier stored in the payment network data warehouse the merchant locations attributes shown in Data Set B are retrieved from the payment network data warehouse. As shown in FIG. 5, Data Set B comprises: a) Merchant Name; b) Merchant Address; c) Post code or zip code; (d) City; (e) State; (f) Country; (g) Merchant Industry; and (h) Merchant Category Codes.

The data set A includes SMEs or merchants location details coming from the Issuer. Data set B has same merchant location details coming from the payment network. The payment network database may include information of millions of merchant locations and merchant location details of the issuing bank are required to locate the merchant details in the payment network data warehouse.

Data Set A and Data Set B are then merged. This is carried out through an inner join using the variables shown in Data Set C. As shown in FIG. 5, Data Set C comprises: a) Post code; (b) City; (c) State; and (d) Country.

The merging of Data Set A and Data Set B takes place in order to identify merchant locations or merchants which are common in Issuer and payment network databases for a given location based on postcode, city or State.

After Data Set A and Data Set B have been merged to form Data Set C, a unique merchant identifier is identified that connects the merchant location information with merchant transactions in the payment network data warehouse. This unique identifier forms Data Set D.

FIG. 6 shows the matching process of step 404 in more detail. As shown in FIG. 6, issuer data 602 is matched with payment network data 604. Both the issuer data 602 and the payment network data 604 identify merchants; however, the data may take different formats. The issuer data 602 comprises merchant identification information such as Merchant_Name and Merchant_Address and merchant location attributes such as Post_Code/Zip_Code; City and State. The payment network data 604 is stored in a payment network merchant database 606 and comprises Merchant Name; Merchant Address; Post code/Zip Code; City and State.

The matching process of step 404 is implemented as a two-step process. Firstly, location information 602a of the issuer data 602 is matched with location information 604a of the payment network data 604. The location information 602a of the issuer data and the location information 604a of the payment network data 604 each comprise indications of Country; State and City. Post code information may also be used in the primary match.

Once records having a primary match are identified, a record having a secondary match within the set of records having a primary match are identified. As shown in FIG. 6, the secondary match is carried out by matching merchant identity information. The merchant identity information 602b of the issuer data 602 is matched with merchant identification information 604b of the payment network data 604. The merchant identity information 602b of the issuer data 602 and the merchant identity information 604b of the payment network data 604 each comprise indications of the Merchant name and Merchant Address.

In the primary match, a merchant location is present in a specific post code or city is identified. However, if there are two merchant locations, for example two branches of the same merchant in the same post code the secondary match is carried out to identify each branch within the post code separately.

When a merchant record of the payment network data 604 having both a primary match and a secondary match to the desired record of the issuer data 602 is identified, this matched identified merchant data 608 is stored and a location identifier is used as a primary unique key. The location identifier is then used as a primary key to extract transaction data corresponding to the merchant from a database of payment network transaction data 610.

Returning now to FIG. 4, in step 406, transaction data corresponding to transactions at the merchant on which analysis is to be carried out is extracted from a payment network transaction database using the identifier of the merchant determined in step 404.

In step 408, the merchant data extraction and analysis module 224b analyses the data corresponding to transactions at the merchant to provide key performance indicators (KPIs) for the merchant. The KPIs may include, for example, the spend per card by product type; an average number of transactions by product type; the number of customers doing single transactions against multiple transactions.

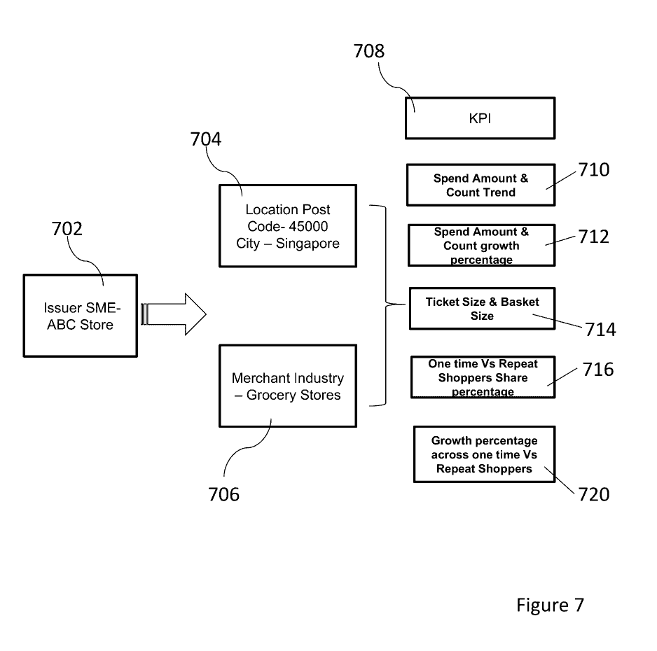

FIG. 7 shows an example of the determination of key performance indicators (KPIs) in an embodiment. In this case, the merchant 702 is an SME. The location 704 and the industry 706 of the merchant are determined. The following KPIs 708 may be determined for the merchant 702: Spend amount and count trend 710 which indicates the spend amount the count of consumers and a trend in these values. Spend amount and count percentage growth 712 indicates the percentage growth in the spend amount and the number of consumers. Ticket size and basket size 714 indicates spend per consumer and the number of items per consumer. One time vs. repeat shoppers share percentage 716 indicates the percentage of consumers making repeat visits. Growth percentage across one time vs. repeat shoppers 720 indicates the relative growth of one-time and repeat shoppers.

FIG. 7 represents the issuer consumer cardholder behavior at those merchants who are using commercial products of the Issuer. The issuer consumer cardholder population would be very small compared to the data contained in the payment network data warehouse. Therefore using the data of one issuer alone variables like market share percentage or spend share percentage across key competitors cannot be accurately computed.

Returning again to FIG. 4, in step 410, the market data extraction and analysis module 224c extracts data corresponding to groups of merchants from the payment network data warehouse. The data extracted in step 410 corresponds to merchants in the vicinity of the merchant under analysis and in the same or related industries. The data extracted in step 410 may be anonymized data having the identity of the merchant removed.

In step 412 the data extracted in step 412 is analyzed. The analysis in step 412 may also use the data extracted in step 406. The analysis in step 412 allows the performance of the merchant being analyzed to be compared with other merchants in the same or related markets operating in the same area.

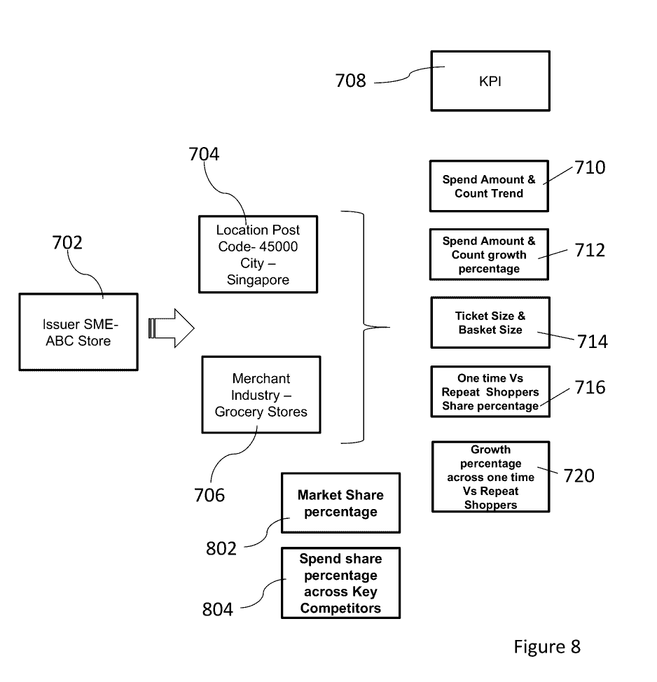

FIG. 8 shows an example of the analysis performed using merchant transaction data and data corresponding to groups of merchants to provide relative market indicators using payment network transactions. The data used to calculate the key performance indicators (KPIs) shown in FIG. 8 corresponds to the total payment network consumer cardholders, thus it includes the data from all issuing banks. This population would be larger and hence variables like market share percentage or spend share percentage across key competitors can be included.

As shown in FIG. 8, the merchant 702 is an SME and the location 704 and industry 706 of the merchant are as described above in relation to FIG. 7. The KPIs 708 shown in FIG. 8 as also as described above in relation to FIG. 7. The additional information provided by the analysis using data from other merchants is market share percentage 802 which indicates the market share of the merchant under analysis and spend share percentage across key competitors 804 which indicates the share of the merchant under analysis with respect to key competitors.

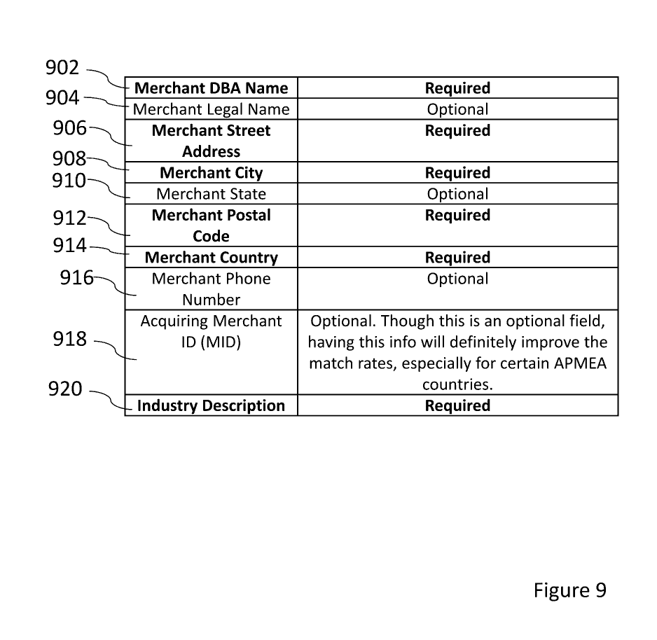

FIG. 9 shows an example of the data required to uniquely identify a merchant in an embodiment. As shown in FIG. 9, the merchant DBA (doing business as) name 902 is required; and the merchant legal name 904 is optional. The merchant street address 906 is required; the merchant city 908 is required; the merchant state 910 is optional; the merchant postal code 912 is required; and the merchant country 914 is required. The merchant telephone number 916 is optional; the acquiring merchant ID (MID) 918 is optional; and the merchant industry 920 is required. As mentioned with respect to the acquiring merchant ID, although some of the fields are optional providing the additional information may assist in identifying matches and therefore improve the match rates. It is noted that while certain fields have been labeled as required in FIG. 9, these requirements represent a particular implementation and embodiments are envisaged in which not all of the fields listed as required in FIG. 9 are required to identify matching merchants in a payment network data warehouse.

Whilst the foregoing description has described exemplary embodiments, it will be understood by those skilled in the art that many variations of the embodiment can be made within the scope and spirit of the present invention.

1. A computer implemented method of analyzing financial transaction data, the method comprising,
receiving, at a server of a payment network, an indication of a merchant from an issuing bank;
determining, using the received indication, a merchant identifier that uniquely identifies the merchant in transaction data stored on a payment network data warehouse;
extracting data corresponding to transactions at the merchant from the transaction data using the merchant identifier; and
analyzing the data corresponding to transactions at the merchant to determine key performance indicators for the merchant.

2. A method according to claim 1, further comprising extracting data corresponding groups of merchants from the transaction data; and analyzing the data corresponding to transactions at the merchant using the data corresponding to groups of merchants to provide relative market indicators for the merchant.

3. A method according to claim 2, wherein the relative market indicators comprise market share indicators for the merchant.

4. A method according to claim 2, wherein the data corresponding to groups of merchants is anonymized data having merchant identifiers removed.

5. A method according to claim 1, wherein the received indication comprises merchant location information and merchant identity information.

6. A method according to claim 5, wherein determining, using the received indication, a merchant identifier that uniquely identifies the merchant in transaction data stored on a payment network data warehouse comprises using the merchant location information to determine a set of possible merchant identifiers and using the merchant identity information to determine a merchant identifier from the set of possible merchant identifiers.

7. A method according to claim 6, wherein using the merchant location information to determine a set of possible merchant identifiers comprises performing an inner join using the merchant location information.

8. A non-transitory computer-readable medium storing executable instructions for analyzing transactions in a system, the instructions, when executed, cause one or more processors to:
receive an indication of a merchant from an issuing bank
determine, using the received indication, a merchant identifier that uniquely identifies the merchant in transaction data stored on a payment network data warehouse;
extract data corresponding to transactions at the merchant from the transaction data using the merchant identifier; and
analyze the data corresponding to transactions at the merchant to determine key performance indicators for the merchant.

9. An apparatus for analyzing financial transaction data comprising:
a computer processor and a data storage device, the data storage device having matching module and a merchant data extraction and analysis module comprising non-transitory instructions operative by the processor to:
receive, an indication of a merchant from an issuing bank;
determine, using the received indication, a merchant identifier that uniquely identifies the merchant in transaction data stored on a payment network data warehouse;
extract data corresponding to transactions at the merchant from the transaction data using the merchant identifier; and
analyze the data corresponding to transactions at the merchant to determine key performance indicators for the merchant.

10. An apparatus according to claim 9, wherein the data storage device further comprises a market data extraction and analysis module comprising non-transitory instructions operative by the processor to: extract data corresponding groups of merchants from the transaction data; and analyze the data corresponding to transactions at the merchant using the data corresponding to groups of merchants to provide relative market indicators for the merchant.

11. An apparatus according to claim 10, wherein the relative market indicators comprise market share indicators for the merchant.

12. An apparatus according to claim 10, wherein the data corresponding to groups of merchants is anonymized data having merchant identifiers removed.

13. An apparatus according to any one of claim 9, wherein the received indication comprises merchant location information and merchant identity information.

14. An apparatus according to claim 13, wherein the non-transitory instructions are operative by the processor to determine, using the received indication, a merchant identifier that uniquely identifies the merchant in transaction data stored on a payment network data warehouse by using the merchant location information to determine a set of possible merchant identifiers and by using the merchant identity information to determine a merchant identifier from the set of possible merchant identifiers.

15. An apparatus according to claim 14, wherein the non-transitory instructions are operative by the processor to use the merchant location information to determine a set of possible merchant identifiers by performing an inner join using the merchant location information.
